(19) United States
(12) Patent Application Publication
(10) Pub. No.: US 2026/0287923 A1
(43) Pub. Date: Sep. 24, 2026

(54) NOSE PAD AND SMART GLASSES

(71) Applicant: GOERTEK TECHNOLOGY CO., LTD., Shandong (CN)

(72) Inventor: Zifang Hu, Shandong (CN)

(73) Assignee: GOERTEK TECHNOLOGY CO., LTD., Shandong (CN)

(21) Appl. No.: 19/167,896

(22) PCT Filed: Oct. 30, 2024
(86) PCT No.: PCT/CN2024/128456

§ 371 Date: Sep. 23, 2025

(30) Foreign Application Priority Data
Nov. 21, 2023 (CN) 202323150545.4

(51) Int. Cl. G02C 5/12; G02C 11/00; H04R 1/02; H04R 1/08; H04R 3/00; H04R 7/04

(52) U.S. Cl. CPC G02C 5/12; G02C 11/10; H04R 1/028; H04R 1/08; H04R 3/00; H04R 7/04; H04R 2410/07

(57) ABSTRACT

The present disclosure discloses a nose pad and smart glasses, wherein the nose pad is applied to the smart glasses and includes a supporting member and a bone conduction component, the supporting member comprising two support portions, one on each side of a nose; the bone conduction component is installed on at least one of the support portions and comprises a housing, a vibration module and a vibration capture module, the housing is installed on one of the support portions, an interior of the housing is partitioned to form a vibration cavity and a detection cavity that are at least partially in communication with each other, the vibration module is configured to capture vibration produced by a user during vocalization, for vibrating air within the vibration cavity, and the vibration capture module is configured to capture, through the air vibrating within the vibration cavity, vibration signal produced by the user during vocalization, and to transmit the vibration signal wired or wirelessly to a control device on smart glasses. The present disclosure aims to propose a nose pad with bone conduction function for calling, voice wake-up/recognition, etc. of the smart glasses.

### CROSS-REFERENCE TO RELATED APPLICATIONS

The present disclosure is a National Stage of International Application No. PCT/CN2024/128456, filed on Oct. 30, 2024, which claims priority to a Chinese patent application No. 202323150545.4 filed with the CNIPA on Nov. 21, 2023 and entitled “NOSE PAD AND SMART GLASSES”, both of which are hereby incorporated by reference in their entireties.

### TECHNICAL FIELD

The present disclosure relates to the technical field of electronic devices, and particularly to a nose pad and smart glasses.

### BACKGROUND

With the continuous development of computer technology, electronic technology, and network application technologies, electronic devices such as smart glasses are increasingly being integrated into daily life.

Examples of current smart wearable devices include smart audio glasses, AR (Augmented Reality)/VR (Virtual Reality), etc., which are typically equipped with functionalities such as voice calling, voice wake-up, and voice recognition. As smart wearable devices trend toward thinner and lighter designs, the demand for more diverse application scenarios is also growing. In outdoor or industrialized environments, due to wind noise and high ambient noise (environmental noise), etc., the voice signal captured by the microphone may be easily overwhelmed by high wind noise and strong environmental noise, hair contact noise, etc. Even after processing by noise reduction algorithms, the voice signal cannot be effectively extracted, resulting in unsatisfactory performance in voice calling, voice wake-up, and voice recognition, or even rendering the microphone inoperable. Therefore, there is an urgent need for a voice recognition structure to address the aforementioned issues.

### SUMMARY

The main objective of the present disclosure is to propose a nose pad and smart glasses, which aim to propose a nose pad with bone conduction function for voice calling, voice wake-up, voice recognition, etc. of the smart glasses.

To achieve the above objective, the present disclosure proposes a nose pad. Specifically, the nose pad includes:
a supporting member including two support portions, one on each side of a nose; and,
a bone conduction component including a housing, a vibration module and a vibration capture module, wherein the housing is installed on one of the support portions, an interior of the housing is partitioned to form a vibration cavity and a detection cavity that are at least partially in communication with each other, the vibration module is configured to capture vibration produced by a user during vocalization, for vibrating air within the vibration cavity, and the vibration capture module is configured to capture, through the air vibrating within the vibration cavity, vibration signal produced by the user during vocalization, and to transmit the vibration signal wired or wirelessly to a control device on smart glasses.

Optionally, the housing is provided with a partitioning part inside, and the housing is partitioned by the partitioning part to form the vibration cavity and the detection cavity;
the partitioning part is opened with a communication hole for communicating the vibration cavity with the detection cavity.

Optionally, the vibration module includes a diaphragm provided in the vibration cavity.

Optionally, a communication hole is provided between the vibration cavity and the detection cavity, and one side of the diaphragm is provided corresponding to the communication hole; and/or,
the vibration module further includes a mass block provided on the diaphragm.

Optionally, the housing has a vibration end where the vibration cavity is formed, and the vibration end is exposed from inner sides of the support portions to contact a nose of the user.

Optionally, the support portions are provided with a flexible outer shell sleeved over the supporting member, and the vibration end is at least partially located inside the flexible outer shell.

Optionally, a communication hole is provided between the vibration cavity and the detection cavity;
the vibration capture module includes a vibration membrane, which is located in the detection cavity and is configured for being vibrated by air so that the vibration capture module generates changes in electrical parameters.

Optionally, a ring-shaped sealing part is provided around one end of the communication hole, and is covered by the vibration membrane.

Optionally, the nose pad further includes a connection part, which is configured for detachably connecting the smart glasses.

Optionally, the connection part is provided with an accommodation cavity therein, one end of the connection part is opened with a first slot communicating with the accommodation cavity, the supporting member is inserted into the first slot, a contact terminal extends through one side of the connection part, one end of the contact terminal located in the accommodation cavity is electrically connected to the vibration capture module, and the other end of the contact terminal extends out of the accommodation cavity to detachably electrically connect to the smart glasses.

Optionally, the support portions are further attached with a circuit board, which is electrically connected to the vibration capture module at one end, and extends from the first slot into the accommodation cavity at the other end to electrically connect to the contact terminal.

Optionally, one end of the contact terminal located in the accommodation cavity is opened with a recess, and at a position corresponding to the recess, the circuit board protrudes with an elastic sheet, which extends into the recess to electrically connect to the contact terminal.

Optionally, a wall of the first slot is opened with a limiting slot, a holding part adapted to the limiting slot is provided on one side of the supporting member at a position corresponding to the limiting slot, and the other side of the supporting member is further provided with a protrusion, which abuts against another wall of the first slot to prevent the holding part from disengaging from the limiting slot; and/or,
the connection part includes a connection base and a cover plate, the cover plate covers the connection base to enclose the accommodation cavity, one end of the connection base is opened with the first slot communicating with the accommodation cavity, and the contact terminal extends into one side of the connection base.

Optionally, a fixing structure is provided between the connection base and the cover plate, and includes a connection structure provided at one end of the connection base and a second slot opened on an inner wall of the connection base, and the cover plate is inserted into the second slot at one end thereof, and at the other end thereof, is fixed to the connection base via the connection structure; and/or,
one side of the cover plate facing away from the accommodation cavity protrudes with a locking emboss, which is configured for adapting to and locking with the smart glasses.

Optionally, the supporting member is provided with a flexible outer shell, which is sleeved over the support portions and abuts against an end face of one end of the connection part, and at the abutment, one of the flexible outer shell and the connection part is opened with a third slot, and the other is provided with an insertion part which is inserted into the third slot.

The present disclosure further proposes smart glasses. Specifically, the smart glasses includes a frame and the nose pad, and the frame includes an eyeglass frame and temple arms which are located on both sides of the eyeglass frame and are provided with a control module; the nose pad includes a supporting member and a bone conduction component, and the supporting member includes two support portions, one on each side of a nose; the bone conduction component includes a housing, a vibration module and a vibration capture module, wherein the housing is installed on one of the support portions, an interior of the housing is partitioned to form a vibration cavity and a detection cavity that are at least partially in communication with each other, the vibration module is configured to capture vibration produced by a user during vocalization, for vibrating air within the vibration cavity, and the vibration capture module is configured to capture, through the air vibrating within the vibration cavity, vibration signal produced by the user during vocalization, and to feedback the vibration signal to a control device on smart glasses; the supporting member of the nose pad is detachably installed on or integrally provided with the eyeglass frame, and the vibration capture module in the nose pad is electrically connected to the control device by wire or wirelessly.

Optionally, the temple arms are further provided with a sound acquisition device, which is electrically connected to the control device by wire or wirelessly.

Optionally, the control device of the smart glasses further includes a processing module, which is in signal communication with the sound acquisition device and the bone conduction component, and is configured for performing fusion processing and noise reduction processing based on vibration signals captured by the sound acquisition device and the bone conduction component.

In the technical solution of the present disclosure, the main objective is to mitigate the impact of environmental wind noise and ambient noise on the smart glasses' ability to capture the user's voice signal. To achieve this, the interior cavity of the housing is partitioned to form the vibration cavity and the detection cavity, the vibration module is configured for capturing vibrations produced by the user during vocalization, to cause the air in the vibration cavity to vibrate, and the vibration capture module is configured to capture, through the air vibrating within the vibration cavity, vibration signal produced by the user during vocalization, and to feedback the recognized vibration signal to the control device on the smart glasses. In this way, the generation and detection of the vocal vibration both occur in the vibration chamber and the detection chamber that are in communication with each other inside the housing, and cannot be affected by external wind noise and strong ambient noise, and the sound wave is generated by the vibration module in response to vibration produced by the user during vocalization and is associated with the user's voice signal. In this way, the vibration signal captured by the vibration capture module can be processed to obtain the user's voice signal, and it is possible to avoid the detection and recognition of environmental wind noise and ambient noise by the vibration capture module, and to significantly reduce the impact of environmental wind noise and ambient noise on the capture of the user's voice signal, which enables the smart glasses to effectively extract the user's voice signal in complex noisy environments, thereby meeting the usage requirements in complex environments. Based on this, the vibration module inside the housing in the present disclosure mainly uses bone conduction to receive vibration produced by the user during vocalization, and since the nose pad position is optimal for human bone vibration during speech, the bone conduction vibration sensing of the vibration module located at the nose pad is also optimal, which may generate a high-sensitivity, high signal-to-noise ratio vocal vibration signal, thereby greatly improving the quality of the obtained voice signal, achieving good calling noise reduction effects, as well as high wake-up and recognition rates for voice wake-up/recognition functions.

### BRIEF DESCRIPTION OF THE DRAWINGS

In order to clearly illustrate embodiments of the present disclosure or technical solutions in the prior art, accompanying drawings that need to be used in description of the embodiments or the prior art will be briefly introduced as follows. Obviously, drawings in following description are only the embodiments of the present disclosure. For those skilled in the art, other drawings can also be obtained according to the disclosed drawings without creative efforts.

FIG. 1 is a perspective schematic view of an embodiment of a nose pad provided by the present disclosure;

FIG. 2 is a perspective schematic view of a partial structure of the nose pad in FIG. 1;

FIG. 3 is a cross-sectional schematic view of the bone conduction component in FIG. 1;

FIG. 4 is a perspective schematic view of an embodiment of the nose pad in FIG. 1;

FIG. 5 is a perspective schematic view of the connection part in FIG. 4;

FIG. 6 is a perspective schematic view of a partial structure in FIG. 5;

FIG. 7 is another perspective schematic view of FIG. 6;

FIG. 8 is a cross-sectional schematic view of the nose pad in FIG. 4 at a limiting slot;

FIG. 9 is a perspective schematic view of another embodiment of the nose pad in FIG. 1;

FIG. 10 is a perspective schematic view of a partial structure of the connection part in FIG. 9;

FIG. 11 is another perspective schematic view of FIG. 10;

FIG. 12 is a perspective schematic view of the cover plate in FIG. 9;

FIG. 13 is a cross-sectional schematic view of the connection part in FIG. 9;

FIG. 14 is a cross-sectional schematic view of the nose pad in FIG. 9 at a limiting slot;

FIG. 15 is a perspective schematic view of a partial structure of the supporting member in FIG. 1;

FIG. 16 is a perspective schematic view of an embodiment of the smart glasses provided by the present disclosure;

FIG. 17 is a schematic flow diagram of voice signal processing of the smart glasses provided by the present disclosure.

### DESCRIPTION OF REFERENCE SIGNS

| No. | Name | No. | Name |
|---|---|---|---|
| 1000 | smart glasses | 4 | flexible outer shell |
| 100 | nose pad | 41 | third slot |
| 1 | supporting member | 5 | connection part |
| 11 | support portion | 51 | accommodation cavity |
| 12 | holding part | 52 | first slot |
| 13 | protrusion | 521 | limiting slot |
| 2 | bone conduction | 53 | contact terminal |
| | component | | |
| 21 | housing | 531 | recess |
| 211 | vibration cavity | 54 | connection base |
| 212 | detection cavity | 541 | insertion part |
| 213 | communication hole | 55 | cover plate |
| 215 | partitioning part | 551 | locking emboss |
| 216 | ring-shaped sealing part | 56 | fixing structure |
| 22 | vibration module | 561 | second slot |
| 221 | diaphragm | 562 | connection structure |
| 222 | mass block | 200 | frame |
| 23 | vibration capture module | 201 | eyeglass frame |
| 231 | vibration membrane | 202 | temple arm |
| 232 | signal processor | 300 | control device |
| 3 | circuit board | 400 | sound acquisition device |
| 31 | elastic sheet | | |

The realization of the objects, functional features and advantages of the present disclosure will be further described with reference to the accompanying drawings in connection with the embodiments.

### DETAILED DESCRIPTION

The technical solutions in the embodiments of the present disclosure will be clearly and completely described below in conjunction with the accompanying drawings in the embodiments of the present disclosure. Obviously, the described embodiments are only a part of the embodiments of the present disclosure, and not all of them. Based on the embodiments in the present disclosure, all other embodiments obtained by a person of ordinary skill in the art without making creative labor fall within the scope of protection of the present disclosure.

It should be noted that if any directional indications (such as up, down, left, right, front, back, etc.) are involved in the embodiments of the present disclosure, such directional indications are only used to explain the relative positional relationships and movements between various components in a specific posture (as shown in the accompanying drawings). If this specific posture changes, the directional indications will change accordingly.

Furthermore, if descriptions such as “first” and “second” are involved in the embodiments of the present disclosure, such descriptions are for illustrative purposes only and should not be construed as indicating or implying relative importance or implicitly specifying the quantity of the indicated technical features. Thus, features defined with “first” and “second” may explicitly or implicitly include at least one such feature. Additionally, the meaning of “and/or” appearing throughout the text includes three parallel options. Taking “A and/or B” as an example, it includes option A, or option B, or the option where both A and B are satisfied. Moreover, technical solutions from different embodiments may be combined, provided that such combination can be achieved by those of ordinary skill in the art. When the combination of technical solutions results in contradictions or is unachievable, such combination of technical solutions shall be deemed non-existent and not within the scope of protection claimed by the present disclosure.

With the continuous development of computer technology, electronic technology, and network application technology, electronic devices such as smart glasses are increasingly being integrated into daily life.

Examples of current smart wearable devices include smart audio glasses, AR/VR, etc., which are typically equipped with functionalities such as voice calling, voice wake-up, and voice recognition. As smart wearable devices trend toward thinner and lighter designs, the demand for more diverse usage scenarios is also growing. In outdoor or industrialized environments, due to wind noise and strong ambient noise (environmental noise), etc., the voice signal acquired by the microphone is easily overwhelmed by high wind noise and strong environmental noise, hair contact noise, etc. Even after processing by noise reduction algorithms, the voice signal cannot be effectively extracted, resulting in unsatisfactory performance in voice calling, voice wake-up, and voice recognition, or even rendering the microphone inoperable. Therefore, there is an urgent need for a voice recognition structure to address the aforementioned issues.

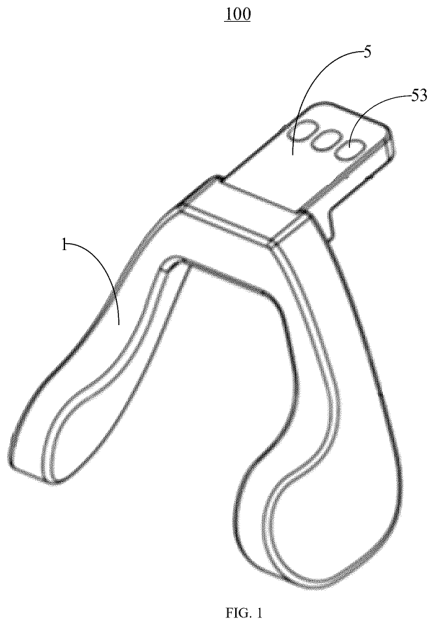

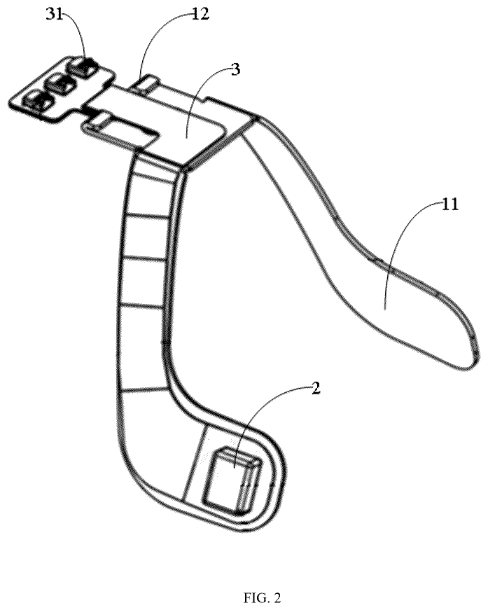

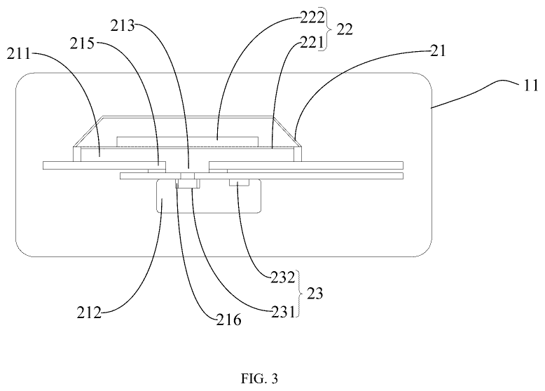

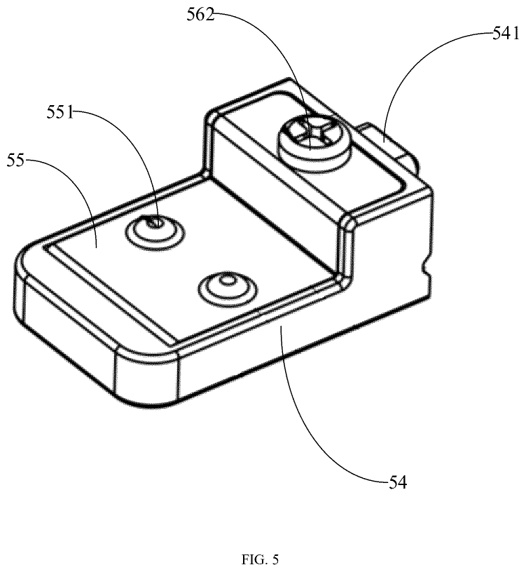

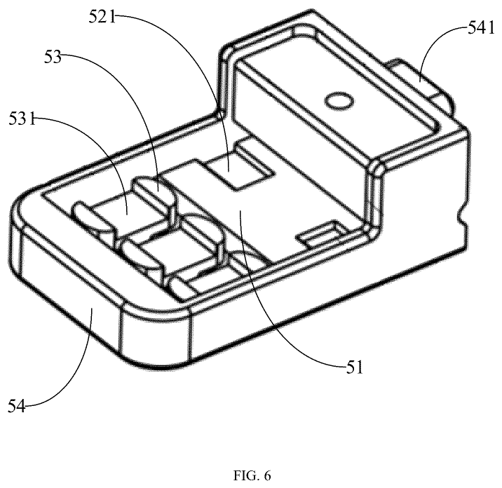

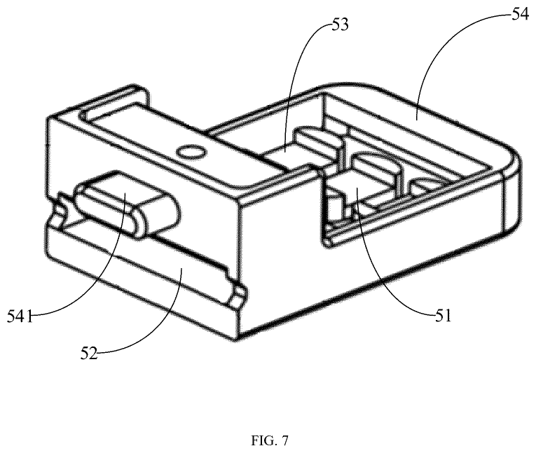

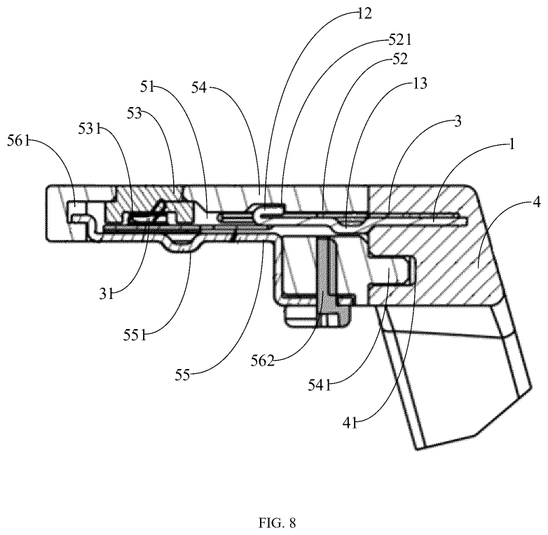

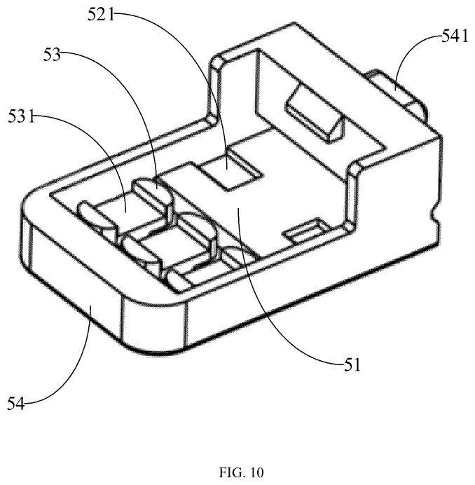

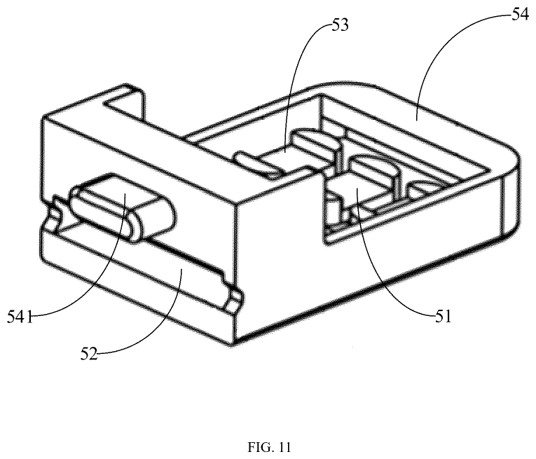

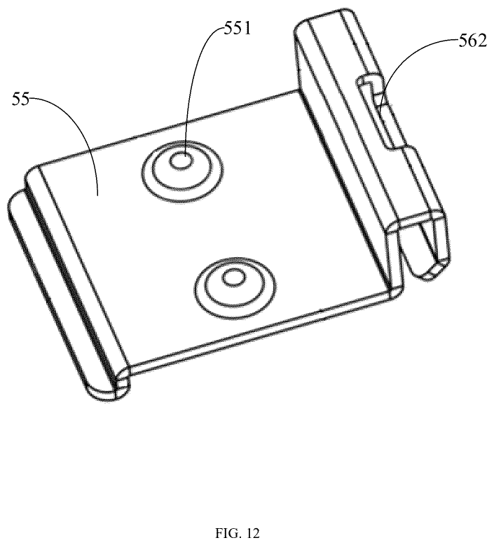

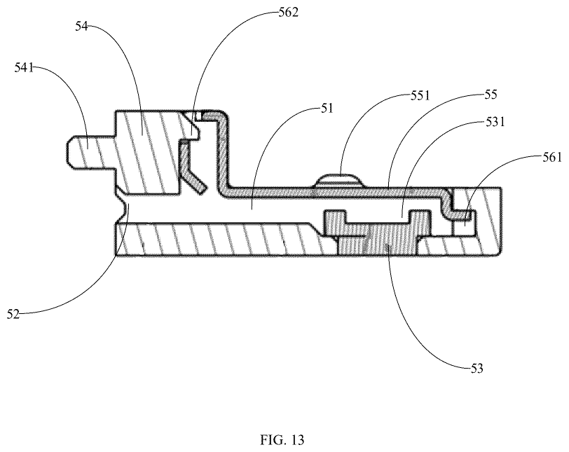

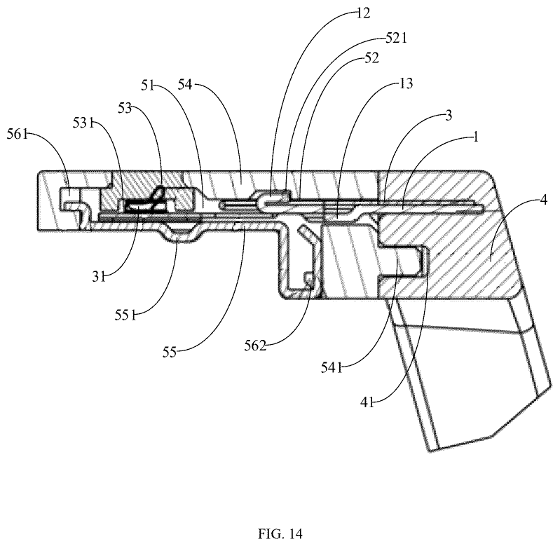

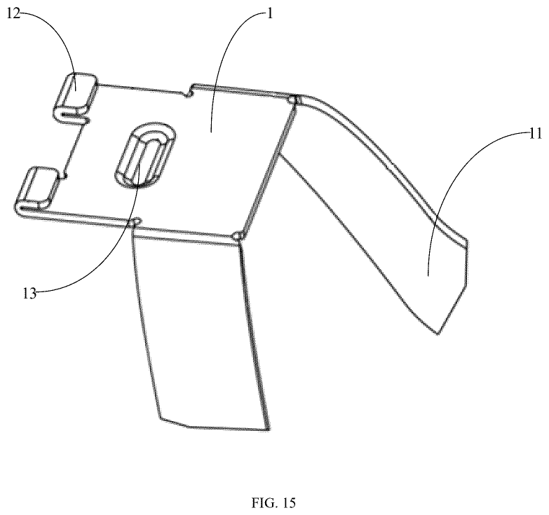

In view of the above, the present disclosure provides a nose pad. FIGS. 1 to 15 are embodiments of a nose pad provided by the present disclosure, and the nose pad will be described below with reference to the specific drawings.

Please refer to FIGS. 1 to 15, the nose pad 100 is used for smart glasses 1000, wherein the nose pad 100 comprises a supporting member 1 and a bone conduction component 2, the supporting member 1 includes two support portions 11, one on each side of a nose; the bone conduction component 2 comprises a housing 21, a vibration module 22 and a vibration capture module 23, wherein the housing 21 is mounted on one of the support portions 11, an interior of the housing 21 is partitioned to form a vibration cavity 211 and a detection cavity 212 that are at least partially in communication with each other, the vibration module 22 is configured to capture vibration produced by a user during vocalization so as to cause air in the vibration cavity 211 to vibrate, and the vibration capture module 23 is configured to capture, through the air vibrating within the vibration cavity 211, vibration signal produced by the user during vocalization, and to transmit the vibration signal wired or wirelessly to a control device 300 on the smart glasses 1000.

In the technical solution of the present disclosure, the main objective is to mitigate the impact of environmental wind noise and ambient noise on the ability of the smart glasses 1000 to capture the user's voice signal. To achieve this, the interior cavity of the housing 21 is partitioned to form the vibration cavity 211 and the detection cavity 212, the vibration module 22 is configured to capture vibrations produced by the user during vocalization to cause the air in the vibration cavity 211 to vibrate, and the vibration capture module 23 is configured to capture, through the air vibrating within the vibration cavity 211, vibration signal produced by the user during vocalization, and to feedback the recognized vibration signal to the control device 300 on the smart glasses 1000. In this way, the generation and detection of the vocal vibration both occur in the vibration chamber and the detection chamber that are in communication with each other inside the housing 21, and cannot be affected by external wind noise and strong ambient noise, and the sound wave is generated by the vibration module 22 in response to vibration produced by the user during vocalization and is associated with the user's voice signal. In this way, the vibration signal captured by the vibration capture module 23 can be processed to obtain the user's voice signal, and it is possible to avoid the detection and recognition of environmental wind noise and ambient noise by the vibration capture module 23, and to significantly reduce the impact of environmental wind noise and ambient noise on the capture of the user's voice signal, which enables the smart glasses 1000 to effectively extract the user's voice signal in complex noisy environments, thereby meeting the usage requirements in complex environments. Based on this, the vibration module 22 inside the housing 21 in the present disclosure mainly uses bone conduction to receive vibration produced by the user during vocalization, and since the nose pad 100 position is optimal for human bone vibration during speech, the bone conduction vibration sensing of the vibration module 22 located at the nose pad 100 is also optimal, which may generate a high-sensitivity, high signal-to-noise ratio vocal vibration signal, thereby greatly improving the quality of the obtained voice signal, achieving good calling noise reduction effects, as well as high wake-up and recognition rates for voice wake-up/recognition functions.

It is understandable that the vibration module 22 and the vibration capture module 23 can be provided on different structures for a split design. For example, independent vibration modules 22 and vibration capture modules 23 can be provided on the support portion 11, with the vibration cavity 211 provided within the vibration module 22 and the detection cavity 212 provided within the vibration capture module 23. Then, through a connection structure, the vibration cavity 211 and detection cavity 212 of the independent vibration module 22 and vibration capture module 23 are in communication with each other in a sealed way, which also achieves the main functions mentioned above. In the present disclosure, it is mainly proposed to provide the vibration module 22 and the vibration capture module 23 in an integrated structure, i.e., enclosed by the housing 21 to form the vibration cavity 211 and the detection cavity 212. The vibration module 22 and the vibration capture module 23 are then provided corresponding to the vibration cavity 211 and the detection cavity 212. On one hand, such an integrated setting of the bone conduction component 2 facilitates its installation on the support portion 11; on the other hand, the vibration cavity 211 and the detection cavity 212 are obtained by partitioning the cavity enclosed by the housing 21 without requiring a connection structure therebetween, simplifying the structure and achieving better sealing. It should be noted that regarding both sides of the support portion 11, one side is used to be close to the user's nose, while the other side is away from the user's nose. The bone conduction component 2 can be provided on either side, but providing the bone conduction component 2 on the side of the support portion 11 close to the user's nose to make the bone conduction component 2 close to the vibration source, it is possible to reduce the loss of the vibration on the support portion 11 and make the vibration directly act on the bone conduction component 2, such that the vibration module 22 vibrates more accurately with the user's vocalization, thereby improving the vibration-capture accuracy and thus enhancing sound recognition and acquisition accuracy.

Specifically, a partitioning part 215 is provided inside the housing 21, and partitions the housing 21 to form the vibration cavity 211 and the detection cavity 212; a communication hole 213 is opened on the partitioning part 215 to communicate the vibration cavity 211 with the detection cavity 212. The vibration cavity 211 and the detection cavity 212 inside the housing 21 can be formed by parts of an overall inner cavity, that is, a single cavity is formed inside the housing 21, with the part near the vibration module 22 designated as the vibration cavity 211 and the part near the vibration capture module 23 designated as the detection cavity 212. However, with such a setup, on the one hand, the integrally molded cavity is not susceptible to local structural adjustments, i.e., it is necessary to adapt the vibration module 22 and the vibration capture module 23, which limits the size and shape of the vibration module 22 and the vibration capture module 23; on the other hand, in turn, adapting the cavity to the vibration module 22 and the vibration capture module 23 of different sizes and shapes may lead to structural molding difficulties. Therefore, in the present disclosure, the partitioning part 215 is provided inside the housing 21 to independently form the vibration cavity 211 and the detection cavity 212 on both sides of the partitioning part 215, which facilitates the shaping and adaptive independent adjustment of the associated structures of the vibration cavity 211 and the detection cavity 212. The communication hole 213 opened in the partitioning part 215 communicates the vibration cavity 211 with the detection cavity 212, which facilitates the integral shaping of the housing 21 and reduces the difficulty of manufacturing, thereby reducing design and manufacturing costs, without affecting the closed communication between the vibration cavity 211 and the detection cavity 212.

Specifically, the vibration module 22 includes a diaphragm 221 provided in the vibration cavity 211. The vibration module 22 is mainly used to receive vibrations during vocalization of a user, and convert them into air vibrations within the vibration cavity 211. That is, it is necessary to provide a structure in the vibration module 22 that vibrates to disturb the air in the vibration cavity 211 when the user vocalizes, and there are many types of such structures, including structures such as a vibrating rod and a vibrating membrane, which can achieve similar functions. The present disclosure mainly adopts an embodiment in which the diaphragm 221 is disposed in the vibration cavity 211, which makes the solution of the acoustic structure more mature and thus more stable.

Further, a communication hole 213 is provided between the vibration cavity 211 and the detection cavity 212, with one side of the diaphragm 221 corresponding to the communication hole 213; the vibration module 22 also includes a mass block 222 provided on the diaphragm 221. The communication hole 213 provided between the vibration cavity 211 and the detection cavity 212 has been described above, which will not be repeated herein. Regarding the structure of the diaphragm 221, its vibration effect is optimal on both sides of the vibration direction. Therefore, in the present disclosure, one side of the diaphragm 221 is provided corresponding to the communication hole 213 to improve the quality of vibration signal transmission. The diaphragm 221 generally has a light structural mass, resulting in a small inertia, and when the housing 21 vibrates with the user's nose, the diaphragm 221 cannot move with it in time, and it is resisted by the air in the vibration cavity 211, resulting in a small vibration amplitude, which affects the generation of airflow fluctuations within the vibration cavity 211, thereby affecting subsequent sound capture quality. Thus, in the present disclosure, the mass block 222 is provided on the diaphragm 221 to improve this situation without affecting the function of the vibration of the diaphragm 221 inducing airflow fluctuations within the vibration cavity 211. Furthermore, it can be understood that the diaphragm 221 can serve as a wall of the vibration cavity 211, to enclose the vibration cavity 211 together with the housing 21. However, its vibration direction is bidirectional, and even if so arranged, it still needs to provide a clearance space on the side facing away from the vibration cavity 211. Therefore, in the present disclosure, the diaphragm 221 is directly provided within the vibration cavity 211 and covers a cross-section of the vibration cavity 211, providing the diaphragm 221 with bidirectional vibration space. At the same time, the diaphragm 221 is provided inside the vibration cavity 211, which also offers certain protective effects. Considering the assembly of the diaphragm 221, the present disclosure provides the housing 21 in a split way, with covering the diaphragm 221 over the main portion of the housing 21 and with another part of the housing 21 forming a protective cover structure that is mounted over the main portion to enclose the vibration cavity 211, which facilitates the installation of the diaphragm 221 and meets the requirement of the diaphragm 221 being located within the vibration cavity 211.

Additionally, the housing 21 has a vibration end where the vibration cavity 211 is formed, and the vibration end is exposed from the inner side of the support portion 11 to contact the user's nose. The above mainly describe the technical characteristics and effects of “providing the bone conduction component 2 on the side of the support portion 11 close to the user's nose to make the bone conduction component 2 close to the vibration source, it is possible to reduce the loss of the vibration on the support portion 11 and make the vibration directly act on the bone conduction component 2, such that the vibration module 22 vibrates more accurately with the user's vocalization, thereby improving the vibration-capture accuracy and thus enhancing sound recognition and acquisition accuracy”. Specifically, to mainly ensure that the vibration cavity 211 at the vibration end is as close as possible to the vibration source, i.e., close to the user's nose, in the present disclosure, the vibration end is exposed from the inner side of the support portion 11 to contact the user's nose, satisfying the above requirement. Based on this, the bone conduction component 2 can be directly provided on the inner side of the support portion 11 or extended through the support portion 11, only exposing the vibration end from the inner side of the support portion 11, which is not limited herein and depends on the actual structural design.

Additionally, a flexible outer shell 4 is provided on the support portion 11 and is sleeved over the supporting member 1, wherein the vibration end is at least partially located inside the flexible outer shell 4. The nose pad 100 is primarily used for contacting and being supported on the user's nose to support the overall smart glasses 1000. Therefore, the nose pad 100 directly contacts the user's nose and applies a certain weight pressure to it. To enhance user comfort, the support portion 11 is covered by the flexible outer shell 4, and after that, the flexible outer shell 4 comes into contact with the user's nose to enhance wearing comfort. Furthermore, the flexible setting of the flexible outer shell 4 also improves user comfort during wearing. Further, according to the above structural characteristic requirement that the vibrating end is attached to the nose of the user and the structural functional requirement of the flexible outer shell 4, the present disclosure arranges at least part of the vibrating end in the flexible outer shell 4 to balance the functional requirements of the two.

Additionally, the vibration capture module 23 includes a MEMS microphone. Compared to other microphones such as traditional ECM (electret condenser) microphones, the MEMS (Micro-Electro-Mechanical Systems) microphone adopted in the present disclosure has a smaller structural volume to reduce the structural volume of the bone conduction component 2, making it easier to be provided on the relatively small nose pad 100. Moreover, the sensitivity of the MEMS microphone is more stable and less susceptible to environmental changes, offering greater practicality.

Specifically, a communication hole 213 is provided between the vibration cavity 211 and the detection cavity 212; the vibration capture module 23 comprises a vibration membrane 231 which is provided corresponding to the communication hole 213 to be vibrated by air so that the vibration capture module 23 generates changes in electrical parameters. The provision of the communication hole 213 between the vibration cavity 211 and the detection cavity 212 has been described in detail above, which will not be repeated herein. The vibration capture module 23 includes the vibration membrane 231, and similar to the structure of the diaphragm 221, the vibration membrane 231 is provided at a position of the detection cavity 212 corresponding to the communication hole 213, so as to efficiently receive the vibration signal transmitted through the communication hole 213 from the diaphragm 221. It should be noted that besides the vibration membrane 231, the vibration capture module 23 is also provided with a signal processor 232 therein, so as to amplify and filter the electrical parameters generated at the vibration membrane 231, and then transmit the electrical parameters to the control device 300 on the smart glasses 1000 for subsequent processing.

Specifically, a ring-shaped sealing part 216 is provided around one end of the communication hole 213, and the vibration membrane 231 covers the ring-shaped sealing part 216. The vibration membrane 231 can be directly placed inside the detection cavity 212 at a position where it covers the communication hole 213 to directly receive the vibration signal transmitted from the diaphragm 221. However, this arrangement does not facilitate the positioning and mounting of the vibration membrane 231 and may result in a gap between the vibration membrane 231 and the communication hole 213, which affects the capture of the vibration signal by the vibration membrane 231, and in turn affects the quality of the later output sound signal. Therefore, in the present disclosure, the ring-shaped sealing part 216 is provided around the communication hole 213, and protrudes from the partitioning part 215. In this way, the vibration membrane 231 only needs to cover the ring-shaped sealing part 216 to ensure its sealed installation, avoiding the aforementioned issues.

Additionally, the nose pad 100 further includes a connection part 5, which is configured for detachably connecting to the smart glasses 1000, enabling the nose pad 100 to be detachable. Clearly, the nose pad 100 can be connected to the smart glasses 1000 via wired or wireless connections.

Further, in one embodiment, the connection part 5 is provided with an accommodation cavity 51 therein, and one end of the connection part 5 is opened with a first slot 52 communicating with the accommodation cavity 51, the supporting member 1 is inserted into the first slot 52, a contact terminal 53 extends through one side of the connection part 5, one end of the contact terminal 53 located in the accommodation cavity 51 is electrically connected to the vibration capture module 23, and the other end of the contact terminal 53 extends out of the accommodation cavity 51 to detachably electrically connect to the smart glasses 1000. The nose pad 100 could be integrally formed with the smart glasses 1000, but considering that the electronic components are provided inside the nose pad 100, there may be a need for later maintenance, repair, or replacement. The present disclosure provides the nose pad 100 to be detachably connected to the smart glasses 1000, and the connection part 5 used for detachable connection to the smart glasses 1000 is designed as an independent detachable structure. Specifically, the nose pad 100 is provided with the connection part 5 for detachable connection to the smart glasses 1000, and at the same time the accommodation cavity 51 is provided within the connection part 5, and the first slot 52 communicating with the accommodation cavity 51 is opened on one side of the connection part 5, so as to enable the supporting member 1 to be inserted into or removed from the accommodation cavity 51 through the first slot 52, achieving the detachable connection between the connection part 5 and the supporting member 1, which facilitates later maintenance and disassembly. In particularly, the connection part 5 is provided with the contact terminal 53, and when there is an abnormality in the electrical connection between the contact terminal 53 and the vibration capture module 23 inside the bone conduction component 2, it is possible to separate the bone conduction component 2 from the contact terminal 53 by taking the supporting member 1 out for easy maintenance and inspection. It should be noted herein that the detachable connection method between the connection part 5 and the supporting member 1 can be various, including but not limited to connection through additional connection structures or magnetic connection structures therebetween. In the present embodiment, the structure where the supporting member 1 is inserted into the accommodation cavity 51 through the first slot 52 is adopted, which facilitates the positioning and docking between the supporting member 1 and the connection part 5 on the one hand, and enables the supporting member 1 to be inserted into the accommodation cavity 51 partially, such that the connection between the connection part 5 and the supporting member 1 is relatively stable. Additionally, considering that the structure of the supporting member 1 needs to be electrically connected to the structure of the smart glasses 1000, the contact terminal 53 is provided on the connection part 5, the connection between the contact terminal 53 and the vibration capture module 23 is located in the accommodation cavity 51 to protect the electrical connection structure. Of course, the electrical connection structure extending from the vibration capture module 23 could also be directly positioned and fixed onto the surface of the connection part 5. However, in this way, on the one hand, the connection between the vibration capture module 23 and the connection part 5 is located on the end face of the connection part 5 without structural protection; on the other hand, the electrical connection structure needs to be positioned and installed on the connection part 5 by itself to correspond to the connection contacts on the smart glasses 1000, resulting in complicated operation and poor accuracy. Therefore, the present disclosure directly adopts a structure where the contact terminal 53 is preset to connect with the electrical connection structure from the vibration capture module 23 in the accommodation cavity 51, so as to avoid the above problem.

Specifically, a circuit board 3 is also attached to the support portion 11, wherein the vibration capture module 23 is electrically connected to one end of the circuit board 3, and the other end of the circuit board 3 extends into the accommodation cavity 51 through the first slot 52 to electrically connect with the contact terminal 53. In this way, one end of the circuit board 3 is electrically connected to the bone conduction component 2, while the other end is inserted into the accommodation cavity 51 through the first slot 52 and is connected to the contact terminal 53. By allowing the circuit board 3 to insert into the accommodation cavity 51 through the first slot 52 and to connect to the contact terminal 53, the circuit board 3 and the supporting member 1 can be synchronously inserted into the accommodation cavity 51, that is, the structural connection between the supporting member 1 and the connection part 5 and the electrical connection between the circuit board 3 and the contact terminal 53 can be simultaneously realized by one installation operation, thereby improving the assembly convenience.

It should be noted that the vibration capture module 23 needs to be in signal communication with the control device 300 on the smart glasses 1000 through an electrical connection structure, which could be a wiring structure connecting the vibration capture module 23 located on the support portion 11 to the control device 300 on the smart glasses 1000. In the present disclosure, by adopting the way that the circuit board 3 is attached to the support portion 11 and the vibration capture module 23 is electrically connected to the circuit board 3 so as to connect the circuit board 3 to the control device 300 on the smart glasses 1000, it is easy for the circuit board 3 to fix and install on the support portion 11, ensuring stable installation.

Further, one end of the contact terminal 53 located in the accommodation cavity 51 is opened with a recess 531, and at a position corresponding to the recess 531, the circuit board 3 protrudes with an elastic sheet 31, which extends into the recess 531 to electrically connect to the contact terminal 53. The circuit board 3 inserting into the accommodation cavity 51 through the first slot 52 has been described above, the contact between the circuit board 3 and the contact terminal 53 is electrically connected, resulting in poor stability. Therefore, in the present embodiment, the recess 531 is opened at one end of the contact terminal 53 located in the accommodation cavity 51, and the elastic sheet 31 is provided at the corresponding position on the circuit board 3, such that when the circuit board 3 is inserted along the first slot 52, the elastic sheet 31 initially contacts the edge of the contact terminal 53, and when continuing to insert the circuit board 3, the elastic sheet 31 is abutted by the contact terminal 53 and is deformed to be attached to the end face of the circuit board 3, so that the elastic sheet 31 can pass over the edge of the contact terminal 53, until the elastic sheet 31 passes over the edge of the contact terminal 53 and reaches the recess 531, and the elastic force of the elastic sheet 31 drives the elastic sheet 31 to restore to extend into the recess 531. In this way, on the one hand, the elastic sheet 31 may contact the side walls of the recess 531, limiting the relative movement of the circuit board 3 with respect to the contact terminal 53 to a certain extent, and thus stabilizing their stability of the contact positioning; on the other hand, the elastic sheet 31 extends into the recess 531, which increases the contact area between the circuit board 3 and the contact terminal 53. In summary, the arrangement of the recess 531 and the elastic sheet 31 improves the stability of their connection.

Additionally, a wall of the first slot 52 is opened with a limiting slot 521, a holding part 12 adapted to the limiting slot 521 is provided on one side of the supporting member 1 at a position corresponding to the limiting slot 521, and the other side of the supporting member 1 is further provided with a protrusion 13, which abuts against another wall of the first slot 52 to prevent the holding part 12 from disengaging from the limiting slot 521. When the supporting member 1 is inserted into the connection part 5 through the first slot 52, merely relying on structural limitations and friction cannot ensure a stable connection between the supporting member 1 and the connection part 5. Therefore, in the present embodiment, the limiting slot 521 is opened in the wall of the first slot 52, and the supporting member 1 protrudes with the holding part 12. In this way, the size of the first slot 52 needs to meet the size of the supporting member 1 plus the holding part 12, that is, as in the present embodiment, the width of the first slot 52 needs to be no less than thickness of the holding part 12 of the supporting member 1, so that the supporting member 1 can be inserted through the first slot 52. When the supporting member 1 is inserted into the first slot 52 and the holding part 12 moves to the limiting slot 521, the holding part 12 may extend into the limiting slot 521 to limit the supporting member 1 from extending into or out of the first slot 52. At this time, in order to ensure that the holding part 12 can be stably held in the limiting slot 521, the protrusion 13 is disposed on a side of the supporting member 1 facing away from the holding part 12. The protrusion 13 abuts against the other wall of the limiting slot 521 to push up the supporting member 1, so that the holding part 12 can be stably held in the limiting slot 521, thereby limiting the supporting member 1. The holding part 12 provided on the supporting member 1 can also be provided as the structure of the elastic sheet 31 on the circuit board 3, and can be deformed itself to avoid the first slot 52 without setting the width of the first slot 52 to be larger, so that the protrusion does not need to push up the supporting member 1 in the wider first slot 52 such that the holding part 12 is maintained in the limiting slot 521 to meet the above functional requirement. However, in practice, the supporting member 1 has greater structural strength and less elasticity than circuit board 3, and is not suitable for processing and shaping a structure similar to the elastic sheet 31. Therefore, in the present embodiment, the edge of the supporting member 1 is bent to form a hook structure and is used as the holding part 12 to extend into the limiting slot 521, so as to facilitate the processing of the structure of the supporting member 1, and meet the structural functional requirements describe above.

Moreover, the connection part 5 comprises a connection base 54 and a cover plate 55, the cover plate 55 covers the connection base 54 to enclose the accommodation cavity 51, one end of the connection base 54 is opened with the first slot 52 communicating with the accommodation cavity 51, and the contact terminal 53 extends into one side of the connection base 54. To further achieve the beneficial effect of a detachable structural design that facilitates installation, disassembly, maintenance, and repair, the present embodiment configures the connection part 5 as a detachable arrangement consisting of the connection base 54 and the cover plate 55, such that when the cover plate 55 is disassembled from the connection base 54, maintenance and overhaul can be carried out in various places within the accommodation cavity 51 so as to facilitate operations such as maintenance and replacement of the contact terminal 53.

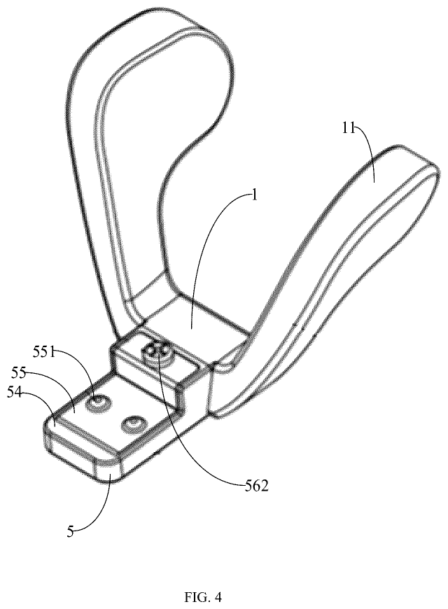

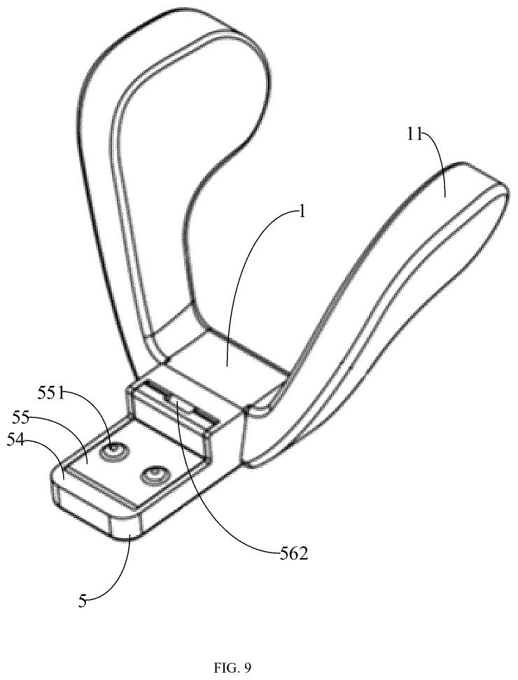

Further, a fixing structure 56 is provided between the connection base 54 and the cover plate 55, and comprises a connection structure 562 provided at one end of the connection base 54 and a second slot 561 opened on an inner wall of the connection base 54, and the cover plate 55 is inserted into the second slot 561 at one end thereof, and at the other end thereof, is fixed to the connection base 54 via the connection structure 562. Based on the detachable arrangement of the connection base 54 and the cover plate 55, it is necessary to provide an additional fixing structure 56 between them to fix and connect them together. It is understood that by setting the fixing structure 56 to a multi-point screw connection structure, the connection base 54 may be stably connected with the cover plate 55, and the screw connection structure is more mature, and has the characteristics of low part cost and simple structure, but needs to be connected with multiple points, resulting in cumbersome operation. Therefore, in the present embodiment, a second slot 561 is provided at one end of the connection base 54 so that one end of the cover plate 55 can be inserted into the second slot 561; the other end of the cover plate 55 can be connected to the connection base 54 through the connection structure 562 to ensure the connection stability of the two, so that the operation is relatively simple, and different installation and disassembling performances can be obtained for different connection structure 562. Specifically, the connection structure 562 in the present embodiment can be the aforementioned screw connection structure (see FIGS. 4 to 8), which has the aforementioned advantages but avoids the cumbersome multi-point threading operations, ensuring stable connection while facilitating installation and disassembly. Further, the connection structure 562 can also be designed as a snap-fit connection structure (see FIGS. 9 to 14), such that when installing the cover plate 55, what needs to do is inserting one end into the second slot 561 and then applying force to snap the other end into the snap-fit connection structure 562, which is simpler in operation, but comparatively, its structural stability is poorer than that of the above-mentioned screw connection structure 562, but in the present embodiment, this can meet the requirements for use.

Further, one side of the cover plate 55 facing away from the accommodation cavity 51 protrudes with a locking emboss 551, which is configured for adapting to and locking with the smart glasses 1000. Based on the structure of the connection part 5, it is also inserted into the smart glasses 1000 in a plug-in manner for structural connection, which is similar to how the supporting member 1 is inserted into the first slot 52. Therefore, similarly, merely relying on the plug-in structure and friction cannot ensure stable connection. Hence, in the present embodiment, the locking emboss 551 protrudes on the outer side of the cover plate 55 so as to enable it to be adapted for locking with the locking holes in the smart glasses 1000, thereby enhancing the stability of the connection between the connection part 5 and the smart glasses 1000.

Additionally, the supporting member 1 is provided with a flexible outer shell 4, which is sleeved over the support portions 11 and abuts against an end surface of one end of the connection part 5, and at the abutment, one of the flexible outer shell 4 and the connection part 5 is opened with a third slot 41, and the other is provided with an insertion part 541 which is inserted into the third slot 41. On the basis that the supporting member 1 is inserted into the first slot 52 to position and connect the connection part 5, an additional plug-in structure is further provided between the flexible outer shell 4 and the connection part 5 to further enhance positioning performance and connection stability. Specifically, on the basis that the first slot 52 is provided on the connection part 5, the insertion part 541 is provided on the end face of the connection part 5, and the third slot 41 is opened in the flexible outer shell 4, the insertion part 541 is inserted into the third slot 41, and the supporting member 1 is inserted into the first slot 52, creating a cross-mating connection between the components, each featuring both a plug and a slot, thereby ensuring the connection stability between the supporting member 1 and the connection part 5.

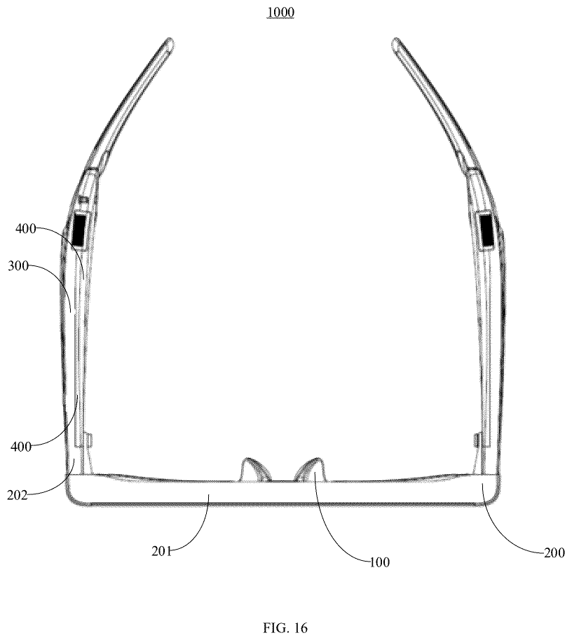

Referring to FIG. 16, the present disclosure further provides smart glasses 1000, which includes a frame 200 and a nose pad 100. The frame 200 includes an eyeglass frame 201 and temple arms 202 which are located on both sides of the eyeglass frame 201 and are provided with a control module 300; the supporting member 1 of the nose pad 100 is detachably installed on or integrally provided with the eyeglass frame 201, the vibration capture module 23 in the nose pad 100 is electrically connected to the control device 300 by wire or wirelessly, and the specific structure of the nose pad 100 refers to the above embodiments. Since the smart glasses 1000 incorporates all of the technical solutions of the above embodiments, it at least possesses all the beneficial effects brought by those embodiments, which will not be repeated herein.

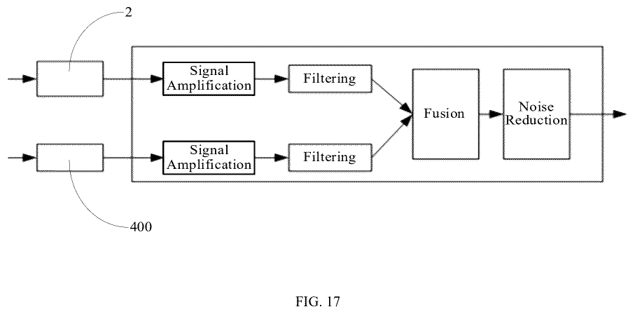

In addition, the temple arms 202 are further provided with a sound acquisition device 400, which is electrically connected to the control device 300 by wire or wirelessly. On the basis that the nose pad 100 is provided with the bone conduction component 2 to capture sound by the vibration of the user's nose, the present disclosure also adds the sound acquisition device 400 on the temple arm 202 to acquire and capture the sound emitted by the user to the external environment. Therefore, the function of the sound acquisition device 400 is similar to that of the bone conduction component 2, both of which are to capture and acquire the sound of the user, so as to meet the functions of the smart glasses 1000, such as call, voice wake-up/recognition, etc., which are implemented by sound. Therefore, both of them can be turned on independently, that is, one of them can be activated alternatively. When both are activated simultaneously (see FIG. 17), the sound acquisition device 400 captures a voice signal transmitted by air vibration, the bone conduction component 2 captures a voice signal transmitted by bone vibration, and the control device 300 of the smart glasses 1000 further comprises a processing module, which is in signal communication (by wire or wirelessly) with the sound acquisition device 400 and the bone conduction component 2 (specifically, the vibration capture module 23), and is configured for performing fusion processing and noise reduction processing based on vibration signals captured by the sound acquisition device 400 and the bone conduction component 2. In addition to the voice signal in the air, there are various noises in the air, such as wind noise and sound signals emitted by other objects, while the bone conduction component 2 only captures the vibration signal of the user's speech and shields other signals transmitted in the air. Therefore, the sound acquisition device 400 can be fused with the signal of the bone conduction component 2 and then superimposed to achieve clear voice noise reduction. Specifically, the vibration voice signal captured by the bone conduction component 2 and the environment voice signal acquired and captured by the sound acquisition device 400 are amplified and filtered. Then the voice signals obtained in two different ways are fused through an algorithm, such as filtering wind noise, filtering specific noise and other applications, and then the voice signals are denoised to achieve high definition and high signal-to-noise ratio transmission of the voice signals. In addition, the smart glasses 1000 is also provided with a speaker for outputting the acquired voice signal or outputting other sound signals, so as to match the functions of the smart glasses 1000.

The above are only preferred embodiments of the present disclosure, and are not intended to limit the scope of the present disclosure. Under the inventive concept of the present disclosure, any equivalent structural modifications made based on the contents of the description and the accompanying drawings of the present disclosure, or any direct or indirect application in other relevant technical fields, are all encompassed within the protective scope of the present disclosure.

1. A nose pad, comprising:
a supporting member comprising two support portions, one on each side of a nose; and,
a bone conduction component installed on at least a first of the two support portions, wherein the bone conduction component comprises a housing, a vibration module, and a vibration capture module, the housing is installed on the first or a second of the support portions, an interior of the housing is partitioned to form a vibration cavity and a detection cavity that are at least partially in communication, the vibration module is configured to capture vibration produced by a user during vocalization, to cause air within the vibration cavity to vibrate, and the vibration capture module is configured to capture, through air vibrating within the vibration cavity, vibration signal produced by the user during vocalization, and to transmit the vibration signal by wires or wirelessly to a control device on smart glasses.

2. The nose pad according to claim 1, wherein the housing is provided with a partitioning part inside, such that the housing is partitioned by the partitioning part to form the vibration cavity and the detection cavity;
the partitioning part is opened with a communication hole for communicating the vibration cavity with the detection cavity.

3. The nose pad according to claim 1, wherein the vibration module comprises a diaphragm provided in the vibration cavity.

4. The nose pad according to claim 3, wherein a communication hole is provided between the vibration cavity and the detection cavity, and one side of the diaphragm is provided corresponding to the communication hole; and/or,
the vibration module further comprises a mass block provided on the diaphragm.

5. The nose pad according to claim 1, wherein the housing has a vibration end where the vibration cavity is formed, and the vibration end is exposed at inner sides of the support portions to contact a nose of the user.

6. The nose pad according to claim 5, wherein the support portions are provided with a flexible outer shell sleeved over the supporting member, and the vibration end is at least partially located inside the flexible outer shell.

7. The nose pad according to claim 1, wherein a communication hole is provided between the vibration cavity and the detection cavity;
the vibration capture module comprises a vibration membrane, which is located in the detection cavity and is configured for being vibrated by air to generate changes in electrical parameters.

8. The nose pad according to claim 7, wherein a ring-shaped sealing part is provided around one end of the communication hole and is covered by the vibration membrane.

9. The nose pad according to claim 1, further comprises a connection part, which is configured for detachably connecting the smart glasses.

10. The nose pad according to claim 9, wherein the connection part is provided with an accommodation cavity therein, one end of the connection part comprises a first slot communicating with the accommodation cavity, the supporting member is inserted into the first slot, a contact terminal extends through one side of the connection part, a first end of the contact terminal located in the accommodation cavity is electrically connected to the vibration capture module, and a second end of the contact terminal extends out of the accommodation cavity to detachably electrically connect to the smart glasses.

11. The nose pad according to claim 10, wherein the support portions are further attached to a circuit board, and the circuit board comprises a first end electrically connected to the vibration capture module, and second end extended from the first slot into the accommodation cavity to electrically connect to the contact terminal.

12. The nose pad according to claim 11, wherein the first end of the contact terminal located in the accommodation cavity is opened with a recess, and the circuit board protrudes with an elastic sheet, which extends into the recess to electrically connect to the contact terminal.

13. The nose pad according to claim 10, wherein a first wall of the first slot is opened with a limiting slot, a holding part adapted to the limiting slot is provided on a first side of the supporting member at a position corresponding to the limiting slot, and a second side of the supporting member is further provided with a protrusion, which abuts against a second wall of the first slot to prevent the holding part from disengaging from the limiting slot; and/or,
the connection part comprises a connection base and a cover plate, the cover plate covers the connection base to enclose the accommodation cavity, one end of the connection base comprises the first slot communicating with the accommodation cavity,
and the contact terminal extends into one side of the connection base.

14. The nose pad according to claim 13, wherein a fixing structure is provided between the connection base and the cover plate, and comprises a connection structure provided at one end of the connection base and a second slot opened on an inner wall of the connection base, and the cover plate comprises a first end inserted into the second slot and a second end fixed to the connection base via the connection structure; and/or,
one side of the cover plate facing away from the accommodation cavity protrudes with a locking emboss, which is configured for adapting to and locking with the smart glasses.

15. The nose pad according to claim 10, wherein the supporting member is provided with a flexible outer shell, which is sleeved over the support portions and abuts against an end face of one end of the connection part, and at an abutment, a first of the flexible outer shell and the connection part is opened with a third slot, and a second of the flexible outer shell and the connection part is provided with an insertion part which is inserted into the third slot.

16. Smart glasses, comprising:
a frame comprising an eyeglass frame and temple arms which are located on both sides of the eyeglass frame and are provided with a control module; and,
the nose pad according to claim 1, the supporting member of the nose pad being detachably installed on or integrally provided with the eyeglass frame, and the vibration capture module in the nose pad being electrically connected to the control device by wire or wirelessly.

17. The smart glasses according to claim 16, wherein the temple arms are further provided with a sound acquisition device, which is electrically connected to the control device by wire or wirelessly.

18. The smart glasses according to claim 17, wherein the control device of the smart glasses further comprises a processing module, which is in signal communication with the sound acquisition device and the bone conduction component, and is configured for performing fusion and noise reduction based on vibration signals captured by the sound acquisition device and the bone conduction component.
